(19) United States
(12) Patent Application Publication
(10) Pub. No.: US 2012/0237291 A1
(43) Pub. Date: Sep. 20, 2012

(54) Joinery System and Method

(76) Inventor: Lorin Dean Friesen, Austin, TX (US)

(21) Appl. No.: 13/049,097

(22) Filed: Mar. 16, 2011

(51) Int. Cl. F16B 19/04; B26D 5/00; F16B 17/00

(52) U.S. Cl. 403/375; 83/13; 83/39

(57) ABSTRACT

An end-lock joinery system allows the formation of one or more elongated members configured to lock end portions with each other. An elongated member can have an end portion that includes, but is not limited to, a protrusion, a shoulder, and a recess, the protrusion and recess each having a width that smoothly tapers from a wider portion to a narrower portion. Various embodiments of the end-lock joinery system can provide different modular configurations to join elongated members and present curved surfaces. The end-lock joinery system can be formed via various methods, including, but not limited to, using a computer numerical control (CNC) machine.

### FIELD

The present invention relates in general to joining elements, and more particularly to forming connections to join elongated members.

### BACKGROUND

In the architectural and construction industries, joinery systems combine multiple members to extend the effective length of a structure. Joinery systems can be used in many situations. For example, where a member of a certain length may be required, but no members of such a length are available, a joinery system can combine two or more smaller members to form a member of the required length. Joinery systems can come in different types that may be specialized for different uses.

One example of a joinery system is a lap joint, which joins two members where an inner surface of each member, called a “cheek”, overlaps a cheek of another member. Several different types of lap joints exist. For example, end laps are the basic form of lap joint and feature cheeks on the ends of members, thereby allowing members to be joined end-to-end. Another example is a cross lap, which is similar to an end lap except that the check for essentially one member is located somewhere other than the end of the member, such as the middle of the member. Dovetail laps are different from end laps and cross laps in that the cheek is formed at angles to be larger as it extends away from the member; this joint is useful when the members will be under tension that would otherwise pull the joint apart. Finally, mitred half laps are constructed so that the joined members will show a mitre; such a joint is the weakest lap joint and is useful only when a mitred corner is desired for the extended member.

Another example of a joinery system is a scarf joint, which joins two members where each member has a flat pane at an angle that mates with a pane on the other member. The basic, or “plain”, scarf joint has two flat panes from two members meeting at an angle. The plain scarf joint does not generally provide strength against tension or compression forces without the use of adhesives or fasteners, and is generally used in creating decorative trim or molding. Plain scarf joints can also be used to extend the length of the board by sliding the panes of the members against each other so that each member does not line up with the other; this has the side effect of reducing the effective thickness of the member. Another type of scarf joint is the keyed hook scarf, often used in wood framing and bridge construction, which generally provides more tensile and compressive strength than plain scarf joints by including interlocking parts; however, even keyed hook scarfs generally require some sort of adhesive or fastener to keep the members locked together.

Currently, joinery systems such as lap joints, while useful for some purposes, do not always provide a strong, attractive joint that can be used to connect two members end-to-end to extend the effective length of the structure. For example, many lap joints, including, but not limited to, end laps do not provide a joint structure that is capable of holding together without an externally-applied fastener. Other joints, such as dovetail joints, might not need a fastener to hold together against certain forces, but feature recesses that are vulnerable to failure by tapering to a minimum width at the shoulder of the joint.

In addition, load-bearing structures made of jointed materials with conventional lap joints are difficult to construct without compromising structural integrity, as the joints may not efficiently transfer the load. Furthermore, continuously-shaped structures are difficult to construct using conventional joints, as each member to be joined must properly align with other members to maintain the aesthetic and structural properties.

Thus, conventional joinery systems, although well suited for some applications, are less than ideal for others.

### SUMMARY

Various embodiments of the present disclosure allow the formation of one or more elongated members configured with interlocking end portions. In at least one embodiment, multiple end portions are fastened using dowels, rivets, or other fasteners. In addition to being configured to interlock, the elongated members can be cut into curved shapes without compromising the structural integrity of the elongated member.

In one aspect of the disclosure, an elongated member having a first end portion includes a protrusion, a shoulder, and a recess. The protrusion is formed from no more than a first half of the thickness of the first elongated member, and has a width that smoothly tapers from a wider portion near to the shoulder to a narrower portion away from the shoulder and next to an end of the first elongated member. The recess is formed from no more than a second half of the thickness of the first elongated member and has a width that smoothly tapers away from a wider mouth next to the shoulder to a narrower portion away from the shoulder and closer to another end portion of the first elongated member. The elongated member can also include an aperture to receive a fastener. An aperture can extend only through the respective cheeks of the protrusion and recess, but not the outer surface of the protrusion, so that the cheeks of the protrusion and recess, along with the apertures, are unseen after being mated with a corresponding recess and protrusion. In some embodiments, the aperture can extend completely through the protrusion or recess. The fastener can be a rivet, a flush rivet, a dowel, a pin, a swaged metal tubing, or some other type of fastener.

The elongated member can also have at least one curved surface extending in an arc with an angle subtended by the arc equaling up to one hundred twenty degrees. The structure of the protrusion can be such that opposite sides of the protrusion each extend in a concave arc having a first radius, measured from the shoulder to a first point, and taper from the first point to a second point near to the narrower portion of the protrusion, where the narrower portion of the protrusion forms a convex arc having a second radius and extends between the second points of the opposite sides of the protrusion. The structure of the recess can be such that opposite sides of the wider mouth of the recess each extend in a concave arc having a first radius from the shoulder to a third point and taper from the third point to a fourth point proximate to the narrower portion of the recess, where the narrower portion of the recess forms a convex arc having a second radius and extending between the fourth points of the opposite sides.

In some embodiments, the elongated member can be constructed of a material having a grain pattern extending substantially parallel to a length of the first elongated member, such as wood, and the protrusion and the recess can be devoid of cuts parallel to the length of the first elongated member. Also, the protrusion and recess of the end portion can be configured to mate with a corresponding protrusion and recess formed in a second elongated member.

In some embodiments, the ends of two pieces of material formed as described herein can be interlocked to form a novel lap joint, where the first protrusion and the first recess are lapped and mated with a matching second recess and second protrusion formed in a second member.

In some embodiments of the disclosure, a computer readable file defining a lap joint design to be cut into a first end portion of the elongated member is loaded, and the elongated member is cut in accordance with the computer readable file to form end portions as described herein. In addition, the cutting can be performed by a computer numerical control (CNC) machine tool or some other suitable device.

### BRIEF DESCRIPTION OF THE DRAWINGS

Aspects of this disclosure will become apparent upon reading the following detailed description and upon reference to the accompanying drawings, in which like references may indicate similar elements:

FIG. 1 is a perspective diagram illustrating an end portion of an elongated member according to various embodiments of the present disclosure;

FIG. 2 is a diagram illustrating an end portion of an elongated member according to various embodiments of the present disclosure;

FIG. 3 is a perspective diagram illustrating the mating of two end portions according to various embodiments of the present disclosure;

FIG. 4 is a perspective diagram illustrating a curved elongated member according to various embodiments of the present disclosure;

FIG. 5 is a diagram illustrating an elongated member according to various embodiments of the present disclosure;

FIG. 6 is a diagram illustrating an elongated member according to various embodiments of the present disclosure;

FIG. 7 is a diagram illustrating the mating of two or more curved elongated members to form a continuous arc according to various embodiments of the present disclosure;

FIG. 8 is a perspective diagram illustrating the mating of two end portions around a reinforcement plate according to various embodiments of the present disclosure;

FIG. 9 is a diagram illustrating a cutting system according to various embodiments of the present disclosure;

FIG. 10 is a flowchart illustrating a method for cutting an elongated member according to various embodiments of the present disclosure; and

FIG. 11 is a block diagram illustrating a hardware environment used to implement a computer according to various embodiments of the present disclosure.

### DETAILED DESCRIPTION

The following is a detailed description of embodiments of the disclosure depicted in the accompanying drawings. The embodiments are described in such detail as to clearly communicate to one of ordinary skill how to make and use the claimed invention. However, the amount of detail offered is not intended to limit the anticipated variations of embodiments; on the contrary, the intention is to cover all modifications, equivalents, and alternatives falling within the spirit and scope of the present disclosure as defined by the appended claims.

A system according to various embodiments can be used to provide continuous surfaces or structural braces with one or more modular interlocking elongated members. Elongated members can include any length of material. Various embodiments can provide an extended structure that is composed of multiple modular interlocking elongated members and capable of performing essentially the same functions as an extended structure of the same size and shape, but is composed of a single solid piece of the same material. The material used can include, but is not limited to, wood, plastic with or without grain patterns, metal, or some other suitable material. Forming the elongated member can include cutting the elongated member from material stock, casting, molding, or the like.

Some embodiments mitigate the need to use long and expensive lengths of material to construct a structure. For example, a wooden load-bearing structure may need to be sixteen feet or more in length; a single sixteen-foot-long wooden beam is relatively expensive, due to the need to form it from a long and straight wooden log. Furthermore, the full length of the single sixteen-foot-long beam must be replaced if any part of the beam is structurally compromised. In contrast, an extended structure composed of eight interlocking two-foot-long elongated members according to some embodiments of the disclosure can bear equivalent loads as the single beam, while utilizing relatively short and inexpensive lengths of wood, thereby cutting down on costs of materials for a structure that, once constructed, can handle equivalent loads. In addition, as the extended structure according to some embodiments of the disclosure could use multiple elongated members to form the extended structure, the loss of structural integrity in one elongated member would not necessitate replacement of the entire structure, as the failed elongated member could simply be swapped out for a satisfactory replacement elongated member. Also, some embodiments can include the joinder of multiple different elongated members composed of different materials. For example, an elongated member composed of one material, such as one type of wood, can be joined to an elongated member composed of a different material, such as plastic, metal, another type of wood, or some other material.

Some embodiments enable the use of interlocking elongated members to construct a pre-designed modular load-bearing structure, such as an arch, truss, support member, or some other type of structure that has been designed to be formed from a combination of multiple elongated members. For example, interlocking elongated members can be pre-designed to fit together in an arch or truss structure, so that a complete structure can be quickly assembled or disassembled as needed. Some embodiments can be used to retrofit older structures or provide additional strength. For example, a pre-designed arch structure made of interlocking elongated members can be assembled to retrofit or supplement existing supports for a roof structure and provide additional protection against events that might otherwise compromise the supports for the roof, such as an earthquake, a hurricane, or some other incident. In addition, a pre-designed truss structure made of interlocking elongated members can be used to retrofit an existing truss structure for similar purposes.

Some embodiments enable the use of interlocking elongated members to construct a pre-designed modular structure for forming other structures. For example, interlocking elongated members can be pre-designed to fit together to form an open or closed mold or form.

Such a mold or form can be used to form sidewalks, driveways, sculptures, load-bearing structures, or other types of structures. In some embodiments, the formed structures can be made of a variety of materials, including, but not limited to, concrete, metal, plastic, or some other type of material.

Some embodiments provide strong interlocking of elongated members through the use of tightly-locking joints. For example, each end portion of an elongated member can be formed by a machine, such as a Computer Numerical Control (CNC) machine, to exactly or nearly exactly connect with another end portion of another elongated member. These end portions, once mated, can be further attached with the use of fasteners, including, but not limited to, dowels, flush rivets, pins, swaged metal tube, or some other type of fastener. For example, apertures can be formed in the end portions to enable a fastener to pass through both end portions and connect them. Furthermore, some embodiments of the end portions can feature fasteners that connect only the inner surfaces, also known as “cheeks”, of the end portions that mate with each other, thereby rendering the fastener not visible to external observation. Finally, some embodiments of the end portions can utilize only the friction between mated surfaces to hold them together by including relatively large amounts of connecting surface area. For example, an end portion that features a recess located over a protrusion will feature, in addition to the side surfaces, a large surface on the cheek of the protrusion that will connect with another protrusion cheek, thereby providing a relatively large amount of surface area to hold via friction, much like a lap joint.

Some embodiments provide strong connections between wooden elongated members by exploiting inherent grain patterns of the wood. For example, some embodiments can include an elongated member that extends generally parallel to the grain pattern, thereby mitigating the probability that the elongated member will fail. Furthermore, some embodiments can include end portions that do not feature any cut surfaces that are parallel or perpendicular to the grain pattern across any significant length, thereby reducing the risk that some portion of the end portion will fail. In addition, some embodiments can include end portions that gradually taper along the length of surfaces of the end portion, thereby reducing the risk of failure due to the presence of angular surfaces.

The risk of compromising structural integrity in curved structures is addressed in some embodiments by using multiple interlocking elongated members, each of which can be curved. For example, an extended structure composed of wood that features curvatures cut into the material risks having structures that run nearly perpendicular to the grain pattern of the wood, thereby rendering them vulnerable to failure, when the structure is a single piece of material with a significant angle of curvature. In contrast, some embodiments of the disclosure include an extended structure with various combinations of curvatures without compromising the structural integrity of the material. One way to achieve this is for each elongated member to include a slight curvature that preserves the overall structural integrity of the individual elongated member. Once the elongated member is combined with multiple elongated members, the extended structure can include an overall angle of curvature that is significant, while not compromising the structural integrity of any part of the extended structure. Where a significant angle of curvature over a shorter distance is required, some embodiments of the disclosure can feature a larger number of shorter elongated members to ensure that each member does not curve too much to compromise its individual structural integrity or the structural integrity of the extended structure.

Some embodiments of the disclosure can mitigate the waste of materials in the construction of temporary structures. For example, a window or door frame buck, composed of multiple interlocking elongated members, can be quickly and cheaply assembled and disassembled on-site. More importantly, the buck composed of interlocking elongated members can be reused, thus reducing waste of materials.

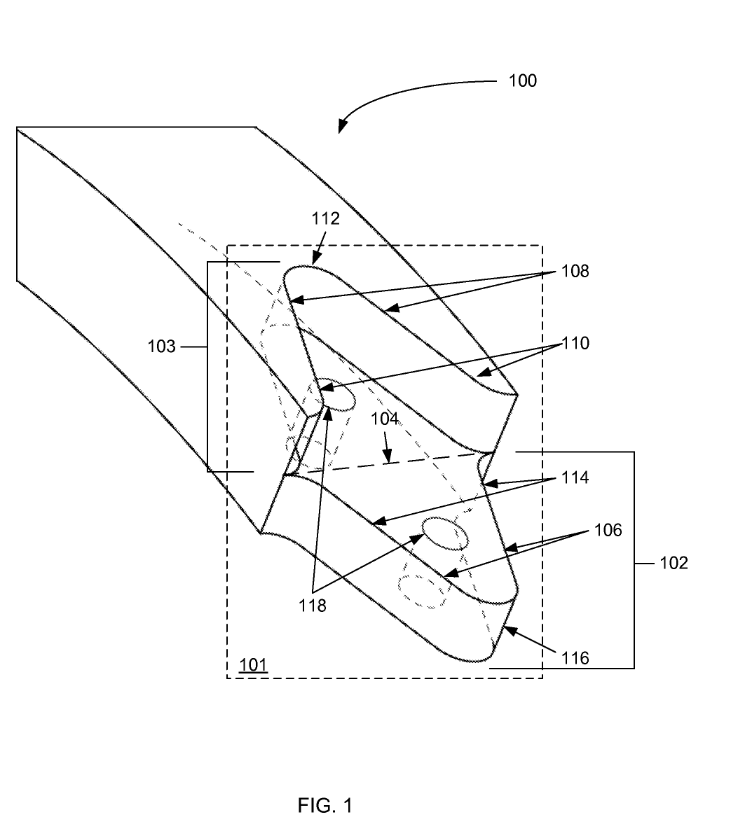

Referring first to FIG. 1, embodiments of the end-lock joinery system are illustrated and discussed. Elongated member 100 includes an end portion 101 that further includes a protrusion 102 and a recess 103, both of which extend from a shoulder 104. The protrusion 102 features a wider portion 114 that extends from the shoulder 104 and tapers into a narrower portion 106 near an end 116 of the elongated member 100. The recess 103 features a wider portion 110 that extends from the shoulder 104 and tapers into a narrower portion near a socket 112 that lies somewhere between the shoulder 104 and the opposite end of the elongated member 100.

In some embodiments, the tapering of the wider and narrower portions of recess 103 and protrusion 102 can be smooth or uniform along their respective lengths. For example, the wider portion 110 and narrower portion 108 of recess 103 can taper at an equal rate between the shoulder 104 and the socket 112, so that the overall shape of recess 103 is generally that of a rounded triangle. Furthermore, the portions of the recess 103 and protrusion 102 can taper in such a manner that there are no angular surfaces on either the recess 103 or the protrusion 102.

In some embodiments, the rate of tapering between the wider and narrower portions can be different. For example, the opposite sides of protrusion 102 can each extend in a concave arc from the shoulder 104 to a first point in or near the wider portion 114, taper from the first point to a second point in or near the narrower portion 106, and both sides can meet in a continuous convex arc extending between the second points of the opposite sides of the protrusion 102 to form the end 116 of the elongated member 100. Furthermore, the opposite sides of the wider mouth of the recess 103 can each extend in a concave arc from the shoulder 104 to a third point in or near the wider portion 110, taper from the third point to a fourth point in or near the narrower portion 108, and both sides can meet in a convex arc extending between the fourth points of the opposite sides of the recess 103 to form the socket 112.

In some embodiments, protrusion 102 can have a base and recess 103 a mouth, each extending respectively over no more than half the thickness of shoulder 104. For example, the surface area of the base of the protrusion 102 can be as thick as one-half the surface area of shoulder 104, while the surface area of the mouth of recess 103 can be as thick as one-half the surface area of shoulder 104. In other embodiments, the surface area of each recess 103 and protrusion 102 can extend over less than one-half of the surface area of shoulder 104.

In some embodiments, the end portion 101 can be configured to mate with a substantially similar opposite end portion, such that the respective cheeks of the recess 103 and protrusion 102 would not be visible to external observation. For example, in the illustrated embodiment, the recess 103 and protrusion 102 are identical in shape so that a recess on an identical opposite end portion would matingly receive protrusion 102 and an opposite protrusion would fit into recess 103. In such an embodiment, the cheeks of the recesses and protrusions of both end portions would not be visible to external observation.

In some embodiments, the end portion 101 includes one or more apertures 118 that extend through at least part of the thickness of the elongated member. For example, as shown in the illustrated embodiment, the end portion 101 can include two apertures 118, one of which extends through the protrusion and one of which extends through the recess. In the illustrated embodiment, each aperture is located an equal distance from the shoulder 104, so that, if an identical opposite end portion were placed over the original end portion 101, with the opposite protrusion placed over the original recess 103 and the opposite recess placed over the original protrusion 102, the apertures of the opposite end portion would align with the original apertures 118.

In some embodiments, each aperture 118 in the end portion 101 can be configured to receive a fastener to enable the end portion 101 to be attached to an opposite end portion. For example, in some embodiments, the apertures 118 can extend through the entire thickness of the elongated member to receive a fastener that extends through both the thickness of the end portion 101 and the thickness of the opposite end portion. As shown in the illustrated embodiment, each aperture 118 extends from a cheek of either the protrusion 102 or the recess 103 to the outer surface of the protrusion. Such an embodiment of the apertures can be configured to receive various types of fasteners, including, but not limited to, dowels, rivets, pins, bolts, swaged metal tubing, or some other type of fastener.

In other embodiments, the aperture can extend only part of the distance through the thickness of the elongated member. For example, each aperture 118 can extend only through either the cheek of the recess 103 or the cheek of the protrusion 102, but not through the outer surface of the protrusion 102, thereby forming a recess in the cheeks of the protrusion 102 and the recess 103 rather than a portal. In such an embodiment, each aperture could receive a fastener, such as a dowel, that would extend between the end portion 101 and an opposite end portion but would not, when the two end portions are mated, be visible to external observation.

In some embodiments, a different number of apertures can be used. For example, an end portion 101 can have a single aperture that is centered exactly between the recess 103 and protrusion 102 at the shoulder 104, such that the aperture would align with the aperture of a substantially identical and opposite end portion.

In some embodiments, the end portion 101 can feature no apertures 118 of any type. For example, in embodiments where the shape of recess 103 and protrusion 102 are virtually identical, the friction between the surfaces of the end portion 101 and an opposite end portion can be sufficient to maintain attachment between the two end portions, much like a handshake between the two end portions gripping each other.

In some embodiments, elongated member 100 can be formed of a material that has a grain pattern. For example, elongated member 100 can be formed of wood, a plastic material with a grain pattern, a crystalline metal structure, or some other material with a grain pattern. In other embodiments, elongated member 100 can be formed of a material that does not have a grain pattern, including, but not limited to, a cast metallic structure or a plastic material that does not have a grain pattern. In some embodiments, the elongated member 100 can be formed by being cut out of a larger piece of material. For example, an elongated member formed of wood can be cut out of a larger piece of wood, including, but not limited to, a board or a log.

In some embodiments where the elongated member 100 is formed of a material having a grain structure, the elongated member 100 can be formed of the material in such a way that the grain pattern runs substantially parallel to the length of the elongated member 100. Furthermore, some embodiments of the elongated member 100 can feature protrusions 102 and recesses 103 that do not have formed or cut surfaces extending parallel to the grain pattern. The above embodiments of elongated members 100 can be less vulnerable to breaking along the grain pattern than other embodiments of elongated member 100, but those more vulnerable embodiments are possible and should be considered encompassed by this disclosure.

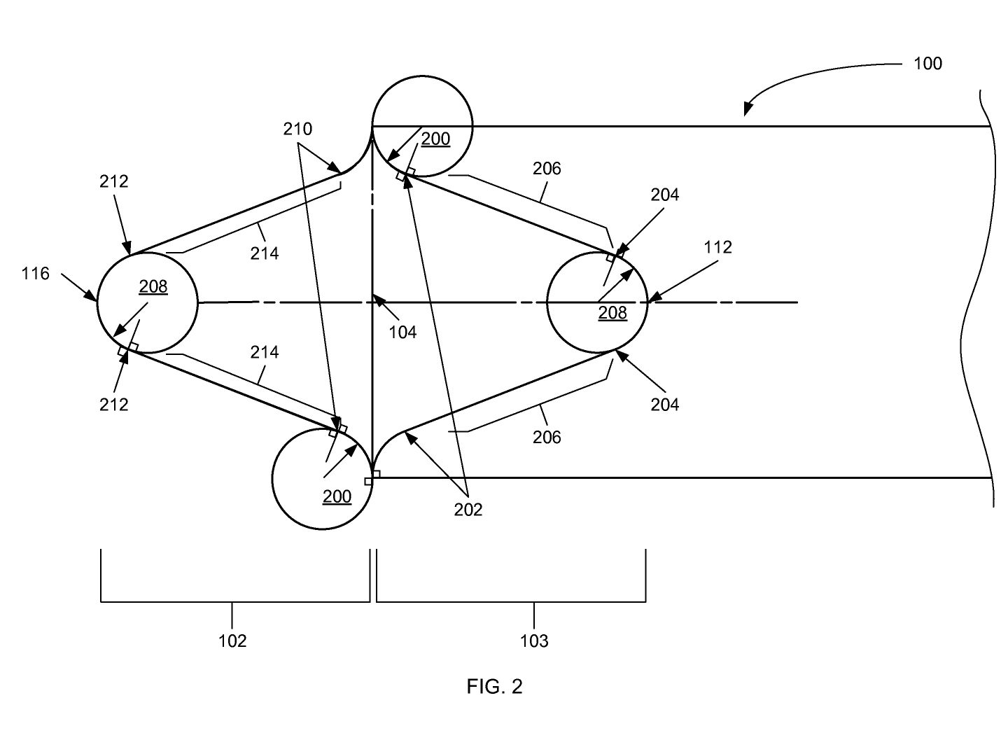

Referring to FIG. 2, embodiments of an end-lock joinery system are illustrated and discussed. In general, the side surfaces of protrusion 102 can each curve in a concave arc of radius 200 extending from shoulder 104 to a first point 210, extend in a planar surface 214 from first point 210 to a second point 212, and each side can meet in a continuous convex arc of radius 208 extending between the two second points 212 to form the end 116 of the elongated member 100. In addition, the side surfaces of recess 103 can each curve in a concave arc of radius 200 extending from shoulder 104 to a third point 202, extend in a planar surface 206 from third point 202 to a fourth point 204, and each side can meet in a continuous convex arc of radius 208 extending between the two fourth points 204 to form a socket 112. In some embodiments, end 116 and socket 112 can be arcuate ends of protrusion 102 and recess 103, respectively.

Furthermore, planar surfaces 214 and 206 need not be straight, but can be curved in some instances.

In some embodiments, radius 200 can be equivalent to radius 208. In other embodiments, planar surfaces 214 and 206 can be of equivalent size and shape. As a result, in some embodiments, the overall size and shape of recess 103 can be sufficiently similar to the size and shape of protrusion 102 such that recess 103 can receive an opposite protrusion of sufficiently similar size and shape to protrusion 102, and protrusion 102 can fit into an opposite recess of sufficiently similar size and shape to recess 103.

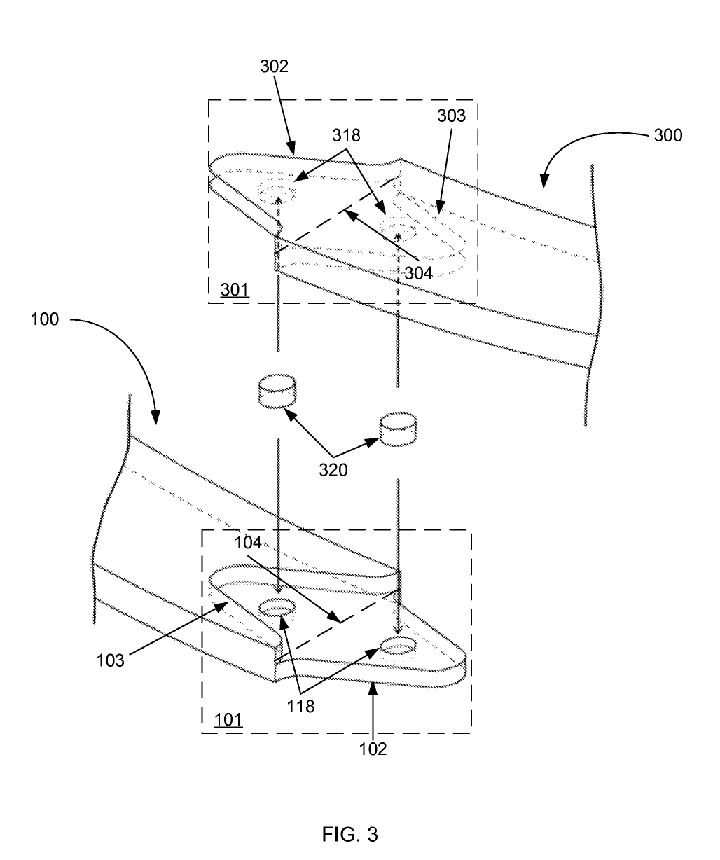

Referring to FIG. 3, embodiments of the end-lock joinery system are illustrated and discussed. As discussed above, in some embodiments the end portion 101 of elongated member 100 can be configured to mate with end portion 301 of elongated member 300. For example, the overall size and shape of recess 103 can be sufficiently similar to the size and shape of protrusion 302 such that recess 103 can receive protrusion 302, and protrusion 102 can fit into recess 303. In some embodiments, the end portions 101 and 301 can form parts of a lap joint. In some embodiments, apertures 118 and 318 are located substantially similar distances from the respective shoulders 104 and 304 of elongated members 100 and 300 to enable apertures 118 to align with apertures 318 when end portion 101 is mated with end portion 301. In some embodiments, apertures 118 or apertures 318 can extend through the entire thickness of the respective elongated member 100 or 300; in some other embodiments, both apertures 118 and 318 can extend through the entire thickness of respective elongated members 100 and 300.

In some embodiments, each aperture 118 in the elongated member 100, and each aperture 318 in elongated member 300, can be configured to receive a fastener 320 to enable elongated member 100 to be attached to elongated member 300. For example, the apertures 118 and 318 can be configured to each receive some part of various types of fasteners 320, including, but not limited to, dowels, rivets, pins, bolts, swaged metal tubing, or some other type of fastener. In other embodiments, the apertures 118 and 318 can extend only part of the distance through the thickness of the elongated member. For example, each aperture 118 and 318 can extend only through either the cheek of the recess 103 or 303 or the cheek of the protrusion 102 or 302, but not through the outer surface of the protrusion 102 or 302, thereby forming a recess in the cheeks of the end portions 101 and 301. In such an embodiment, each aperture 118 and 318 could receive part of a fastener 320 that would extend between end portion 101 and end portion 301 but would not, when the two end portions are mated, be visible to external observation.

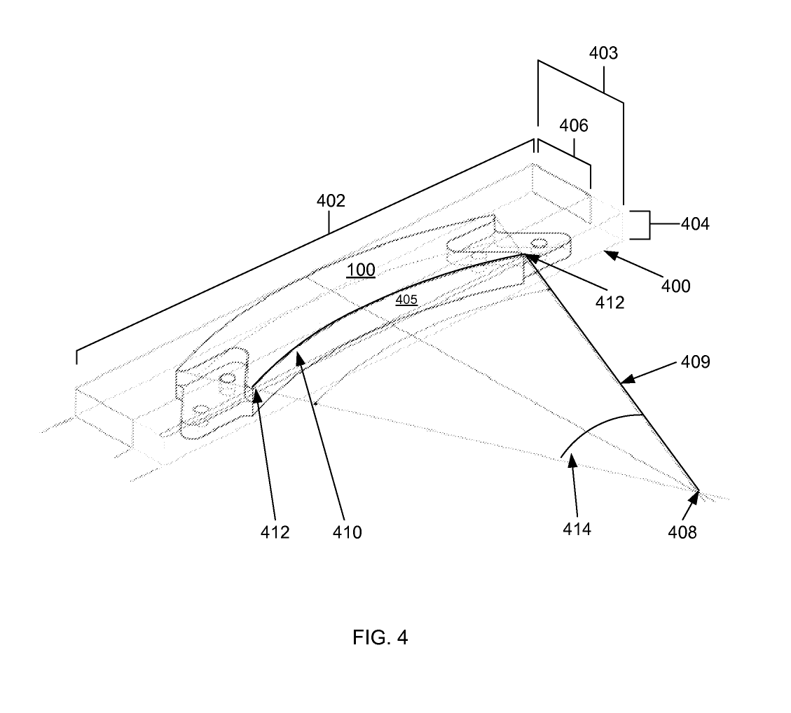

Referring to FIG. 4, embodiments of the elongated member 100 are illustrated and discussed. In the illustrated embodiment, elongated member 100 is formed from a material in the shape of a rectangular prism or board 400 having length 402, width 403, and depth 404.

In some embodiments, elongated member 100 is formed from board 400 so that elongated member 100 includes one or more curved surfaces. As shown in the illustrated embodiment, elongated member 100 can be cut from board 400 so that one or more sides of elongated member 100 curves in an arc 410 having a center 408 and radius 409 between two endpoints 412 on the elongated member 100. In such embodiments, the elongated member 100 cut from the board 400 will have a reduced effective width 406. The angle 414 is subtended by the arc 410 between the two endpoints 412. To standardize the number of elongated members 100 required to form a circle or a portion thereof, angles 414 that add up to 90 degrees can allow the connection of elongated members 100 with a similar size and curvature 410 to create an aggregate structure that extends in a 90-degree arc. For example, a curving surface that makes a 90-degree angle and is made of elongated members 100 can be composed of two elongated members 100 curving in 45-degree arcs, three elongated members 100 curving in 30-degree arcs, four elongated members 100 curving in 22.5-degree arcs, five elongated members 100 curving in 18-degree arcs, six elongated members 100 curving in 15-degree arcs, or some other number of elongated members 100 having a certain subtended angle 414.

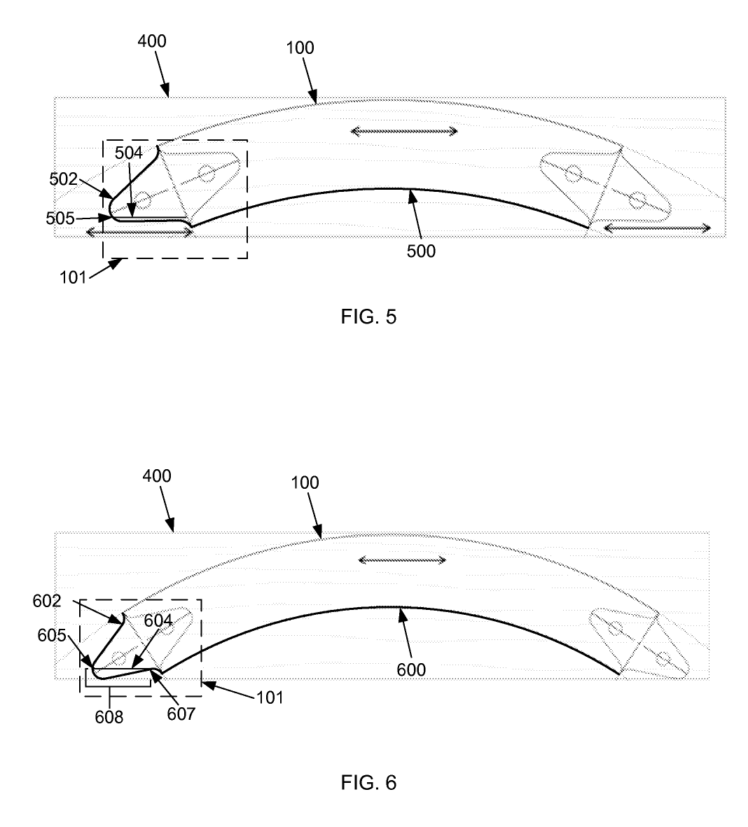

Referring now to FIG. 5, embodiments of the elongated member 100 are illustrated and discussed. In the illustrated embodiment, elongated member 100, having end portions 101 and curvature 500, is formed from board 400. In some embodiments, board 400 features a grain pattern 504 that extends parallel or nearly parallel to the length of board 400. For example, as shown in the illustrated embodiment, grain pattern 504 extends nearly parallel to the length of board 400. In some embodiments, the subtended angle of the curvature 500 is such that the grain pattern 504 extends virtually parallel with the edge 502 of the cheek of the end portion 101 and intersects the edge 502 only once at point 505. Because the grain pattern 504 does not intersect the edge 502 of the end portion 101 more than once, the structural integrity of the end portion 101 can be maintained. An angle of curvature 500 represents the maximum subtended angle of curvature 500 that is intended to prevent impairment of the structural integrity of elongated member 100. For example, where the subtended angle of curvature 500 is 45 degrees, any subtended angle greater than 45 degrees might lead to the grain pattern 504 intersecting the edge 502 of the end portion more than once, potentially rendering the end portion 101 vulnerable to structural failure.

In some embodiments, the angle of curvature is restricted to not exceed a desired threshold, in order to preserve the integrity of the elongated member 100. For example, embodiments of elongated member 100 can be cut from board 400 in such a manner as to ensure that the angle of curvature does not exceed 45 degrees for any single elongated member 100.

In some embodiments, the taper of edge 502 can be designed to mitigate the risk of structural failure from the grain pattern. For example, the tapering of the cheek can be less than half the difference of the angle of curvature 500 and 180 degrees. Such an embodiment can mitigate the risk of the grain pattern intersecting the edge 502 more than once, regardless of the angle of curvature 500.

In restricting the maximum allowable angle of curvature in accordance with some embodiments, the likelihood of failure of the elongated member 100 can be reduced, especially for elongated members 100 formed of wood. For example, if elongated member 100, formed of wood, features a curvature 500 with an angle in excess of 45 degrees, the elongated member 100 may be at an increased risk of failure, as one or more formed surfaces of elongated member 100 may be intersected by the grain pattern 504 more than once. The 45-degree angle therefore is a natural limit to the angle of curvature 500, as it is the angle beyond which there is a guaranteed loss of structural integrity for at least one formed surface of elongated member 100. Nevertheless, embodiments featuring an elongated member 100 with a curved surface 405 extending in an arc 410, the subtending angle 414 of which exceeds 45 degrees, are possible and should be considered encompassed by this disclosure.

Referring now to FIG. 6, embodiments of the elongated member 100 are illustrated and discussed. In the illustrated embodiment, elongated member 100, having end portions 101 and curvature 600, is formed from board 400. In some embodiments, board 400 features a grain pattern 604 that extends parallel or nearly parallel to the length of board 400. For example, as shown in the illustrated embodiment, grain pattern 604 extends nearly parallel to the length of board 400. In some embodiments, the edge 602 of the cheek of the end portion 101 extends beyond the grain pattern 604, such that the grain pattern intersects the edge 602 twice at points 605 and 607. Because the grain pattern 504 intersects the edge 602 more than once, the structural integrity of the end portion 101 might be compromised, and the portion of the cheek 608 that extends beyond the grain pattern 604 can be vulnerable to structural failure.

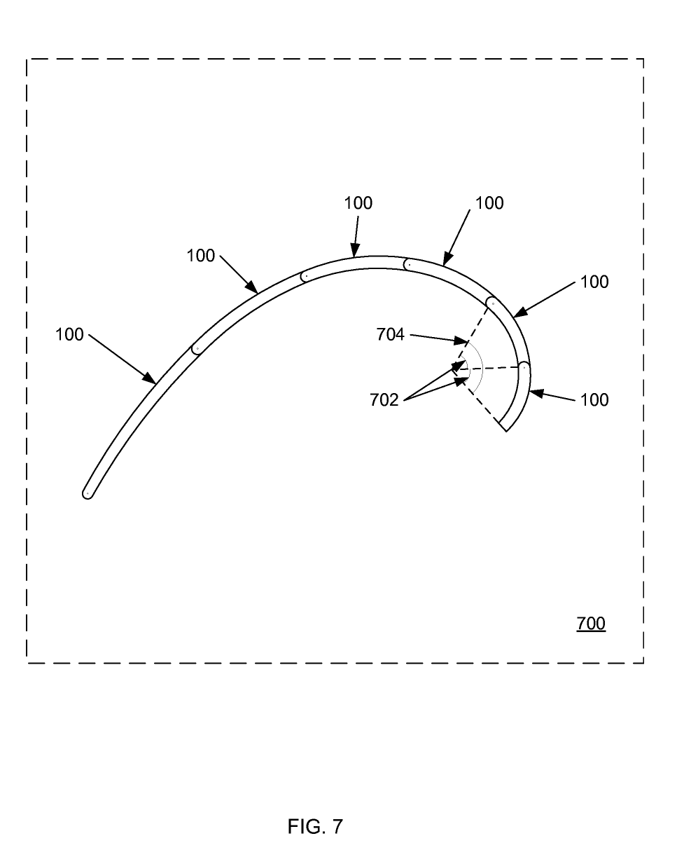

Referring now to FIG. 7, embodiments of the end-lock joinery system are illustrated and discussed. In some embodiments, the end-lock joinery system 700 can include more than one elongated member 100. For example, as shown in the illustrated embodiment, end-lock joinery system 700 includes multiple elongated members 100, which are mated at substantially similar end portions 101 (FIG. 1). In some embodiments, the multiple elongated members 100 can feature similar curved surfaces with similar subtended angles 702, so that when the multiple elongated members 100 are mated, the end-lock joinery system 700 appears to feature a single elongated member with a curved surface of an angle 704 that is the sum of the subtended angles 702 of the multiple elongated members 100.

In some embodiments, each elongated member 100 can feature a curved surface with a different curvature. For example, as shown in the illustrated embodiment, each of the multiple elongated members 100 can feature a curved surface with a difference subtended angle 702, so that the combined end-lock system 700 takes on the appearance of a single elongated member with a curvature than changes constantly along its length. In some other embodiments of the end-lock system 700, the multiple elongated members 100 can include one or more elongated members 100 with no curved surfaces.

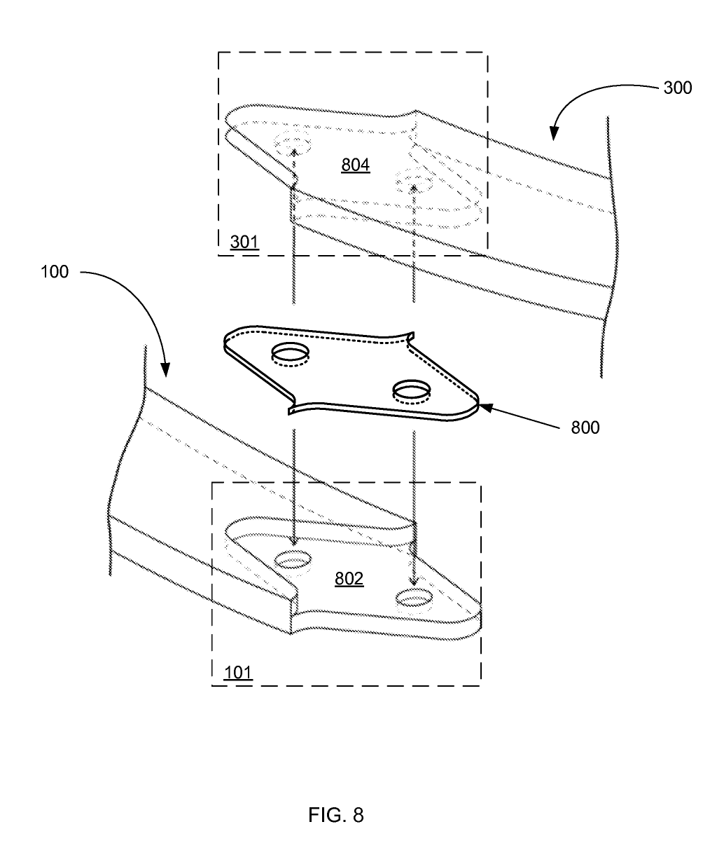

Referring now to FIG. 8, embodiments of the end-lock joinery system are illustrated and discussed. In some embodiments, reinforcement plate 800 can be located between end portions 101 and 301 to reinforce the attachment of elongated members 100 and 300. For example, a plate 800 can fit between the cheeks 802 and 804 to provide additional strength to the connection and reduce the probability of structural failure. In some embodiments, reinforcement plate 800 can reinforce the attachment of elongated members 100 and 300 when one or both elongated members 100 and 300 have both a grain pattern and a large angle of curvature. In such embodiments, reinforcement plate 800 can mitigate the risk of structural failure of the joint by transferring some of the load on the joint to reinforcement plate 800. In some embodiments, reinforcement plate 800 can be constructed of metal, plastic, a type of wood, or some other material. For example, in the illustrated embodiment, a metal reinforcement plate 800 can augment the strength of an attachment between wooden elongated members 100 and 300. In some embodiments, other reinforcement methods can also be used, in conjunction with, or in place of, reinforcement plate 800. For example, a bracket, sheath, sleeve, or some other apparatus made of metal, plastic, wood, or some other material can extend over the exterior surfaces of both elongated members 100 and 300 to reinforce the joint. In addition, an external apparatus can extend into the external surfaces of one or both of elongated members 100 and 300.

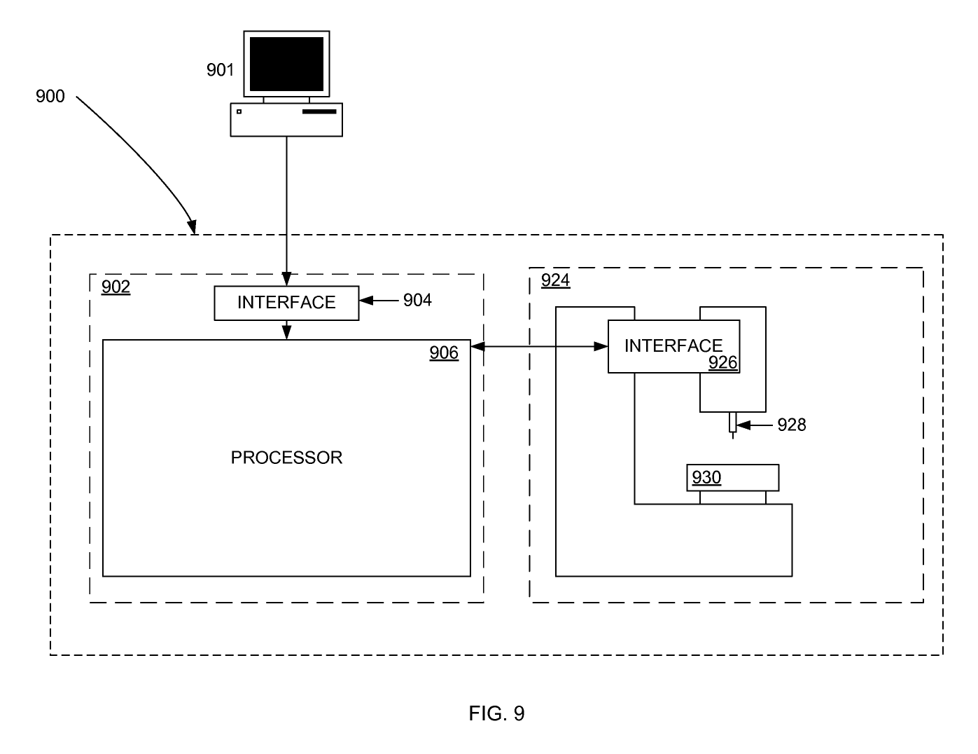

Referring now to FIG. 9, embodiments of a system for forming one or more elongated members are illustrated and discussed. In some embodiments, such as where an elongated member is formed by being cut from a larger material stock, the elongated member-forming system 900 includes a Machine Control Unit (“MCU”) 902, and a Machine Tool (“MT”) 924. the elongated member-forming system 900 includes a user device 901. In some embodiments, the user device 901, MCU 902 and MT 924 can be part of a Computer Numerical Control (“CNC”) machine tool system.

In some embodiments, a design that defines one or more elongated members can be stored in a computer readable file format in a user device 901, including, but not limited to, a computer, mobile device, or PDA. For example, a design that defines an elongated member can be stored in user device 901 as a Computer Aided Drafting (“CAD”) file. The design can also exist in the form of a Drawing Exchange Format (“DXF”) file, or some other type of electronic format. Furthermore, the design can be translated from one computer readable file format to another. In some embodiments, the design that defines an elongated member can be transmitted from the user device 901 to the MCU 902 via a wired or wireless connection. For example, in a CNC system, the user device can translate the design from a CAD format to a DXF format and transmit the design to the MCU 902. In some embodiments, the design can include instructions regarding how the MT 924 should form the designed elongated members, and can also include instructions regarding how to incorporate feedback from MT 924.

In some embodiments, the MCU 902 can include an interface 904 and a processor 906. The interface 904 can receive designs from the user device 901. The interface 904 transmits the design to the processor 906, which in turn transmits the design to the MT 924.

In some embodiments, the MT 924 can include an interface 926, one or more machine tools 928, including a router, a sawblade, or some other tool, and a table 930. In some embodiments, the interface 926 can receive the design from the processor 906 in the MCU 902. The interface 926 can use this information to manipulate the position of a movable part of the MT 924. For example, in embodiments where the one or more machine tools 928 are only movable in the z directional axis, or are not movable at all, the interface 926 can order the one or more machine tool to activate and can manipulate the position of the table 930 in the x, y, or z directional axes to form the design of the elongated member from a material stock that is located on the table. In some embodiments, the table 930 can remain stationary in one or more directional axes, and the one or more machine tools 928 can move in one or more directional axes to form the design of the elongated member from a material stock that is located on the table. In some embodiments, one of the machine tools 928 on the MT 924 can include, but is not limited to, a router, a drill bit, or a sawblade. In some embodiments, the interface 926 can transmit information to the MCU 902. For example, the interface 926 can transmit feedback information, information indicating the status of the cutting process, or some other information.

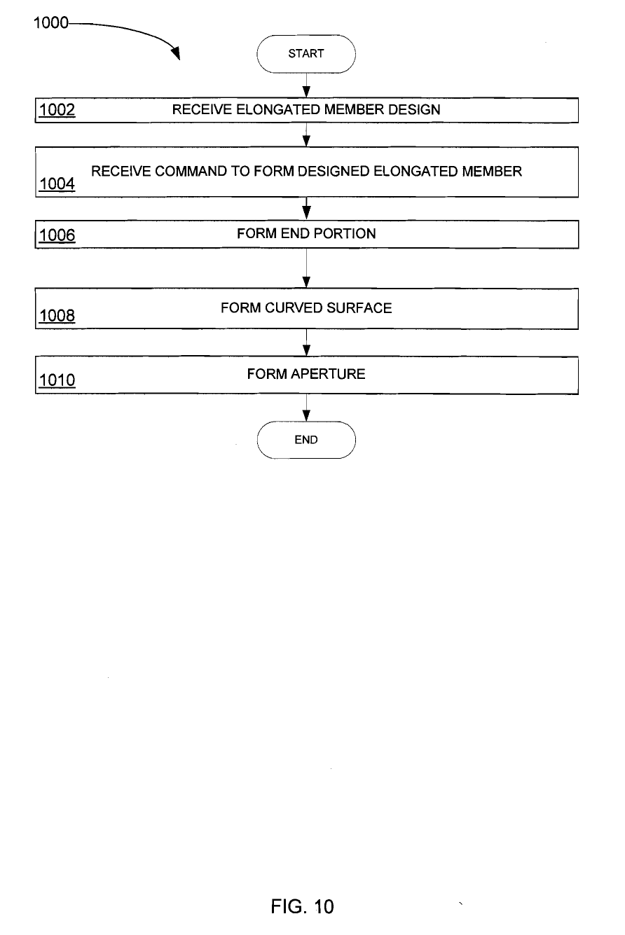

Referring next to FIG. 10, a method 1000 according to various embodiments is discussed. Method 1000 includes receipt of a design for an elongated member, as shown in block 1002. The design can include, but is not limited to, instructions regarding how to manipulate one or more tools to form the elongated member. In some embodiments, the instructions can be in the form of a set of algorithms. For example, in the some embodiments where method 1000 is performed by a CNC machine, the instructions can include, but are not limited to, an instruction to cut a surface curved in an arc in the form of an algorithm of the structure G2 Xx Yy Ii Jj Ff, where “x” and “y” are the x,y coordinates of an arc end point, “i” and “j” are the respective distances on the x-axis and y-axis from an arc start point to an arc center point, and “f” is a new feed rate, if desired (if no “f” is provided, the last active federate can be used). G2 would indicate a clockwise motion by a CNC machine tool, while G3 would indicate a counter-clockwise motion by a CNC machine tool. As a further example, an instruction in some embodiments to cut a clockwise 90-degree three-inch radius arc from the origin coordinates (x=0, y=0) and no change in feedrate can be expressed as follows: G2 X3.0 Y3.0 I3.0.

In some embodiments, the instructions can order that the elongated member design be formed with a minimum number of movements of a machine tool. For example, in an embodiment where a design for the elongated member 100 shown in FIG. 1 is to be cut from a board of wood with a CNC machine tool, the instruction can command that the end portion be cut with only two movements of the machine tool, with the recess being cut in one movement of the machine tool and the protrusion being cut in one movement of the machine tool, and each aperture being cut with one movement of the machine tool.

As shown in block 1004, method 1000 can include receiving a command to form the elongated member defined in the design out of a material stock. As discussed above, forming a design can include, but is not limited to, cutting, casting, molding, shaping or the like. In some embodiments, the command can be transmitted from a user device, such as a workstation or other computer system.

As illustrated by block 1006, an end portion can be formed out of a material stock. In some embodiments, the end portion can be formed from a material by being cut from the material, or it can be formed in some other fashion, such as being cast. For example, in an embodiment where the end portion is formed from a quantity of wood, such as a board, the end portion design can be cut from the board with the use of a router tool, a sawblade, or some other type of tool. In some embodiments, the end portion can be formed by cutting a protrusion out of the material stock that smoothly tapers along its length from a base to an end, by cutting a recess into the material stock that smoothly tapers along its length from a mouth to a socket, and by cutting a shoulder out of the material stock. In some embodiments, the protrusion and recess can be cut to include curving surfaces. For example, the respective end and socket of the protrusion and recess can be cut to curve in a convex arc between two points on the protrusion and recess, respectively.

In some embodiments, the end portion can be formed through the use of a small number of cuts. For example, the protrusion, recess, and shoulder can each be cut out of the material stock with a single cutting motion by a tool, such as a router, drill, bit, sawblade, or other tool.

As shown in block 1008, method 1000 can include forming a curved surface. In some embodiments, formation of the curved surface can include cutting the curved surface from a material stock. For example, in an embodiment where the curved surface is formed from a quantity of wood, the curved surface can be cut from the wood through the use of a machine tool, including, but not limited to, a router tool, a sawblade, or some other type of tool. Formation of the curved surface can include cutting a surface into the material stock that curves in an arc between two points, the arc having a defined angle subtended in the arc. For example, a machine tool can cut a surface between two points on the material stock by curving along an arc that has a defined arc center and a defined subtended angle of the arc.

As shown in block 1010, method 1000 can include forming an aperture from a material stock. As discussed above, in some embodiments, formation of the aperture can include cutting the aperture from a material stock. For example, in an embodiment where the aperture is formed from a quantity of wood, the aperture can be cut into the wood through the use of a machine tool, including, but not limited to, a router tool, a drill bit, or some other type of tool. In some embodiments, formation of the aperture can include cutting a defined distance into the material stock at a defined location on the material stock. For example, a machine tool can cut an aperture by drilling into the material stock by a defined distance at a location that is a defined distance between the shoulder of the end portion and either the end of the protrusion or the socket of the recess.

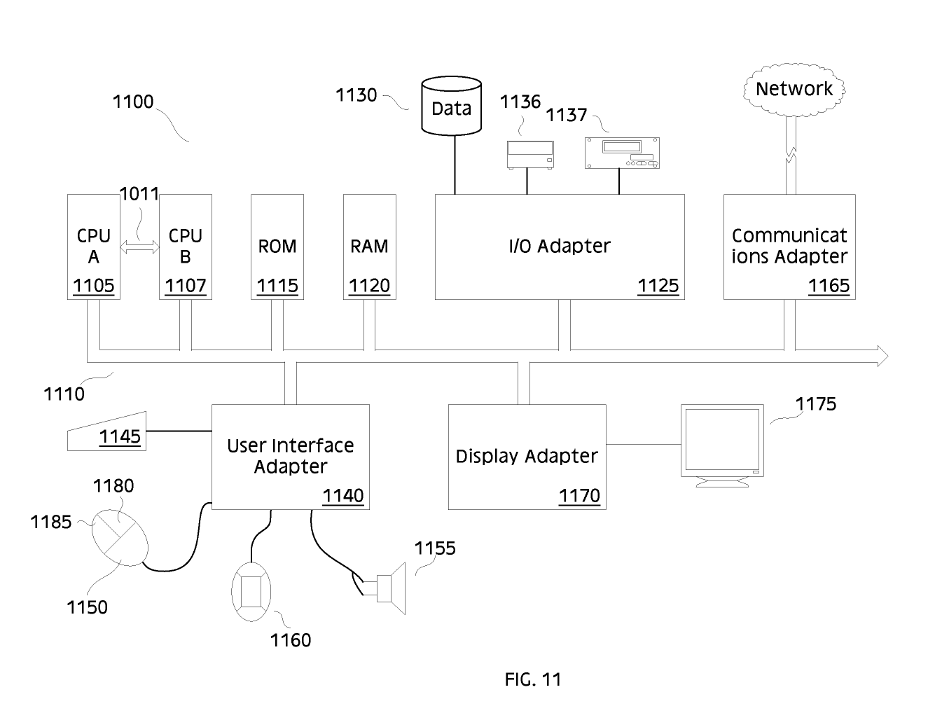

Referring now to FIG. 11, a high-level block diagram of a processing system suitable for use in implementing a joinery system is illustrated and discussed. Processing system 1100 includes one or more central processing units, such as CPU A 1105 and CPU B 1107, which can be conventional microprocessors interconnected with various other units via at least one system bus 1110. CPU A 1105 and CPU B 1107 can be separate cores of an individual, multi-core processor, or individual processors connected via a specialized bus 1111. In some embodiments, CPU A 1105 or CPU B 1107 can be a specialized processor, such as a graphics processor, other co-processor, or the like.

Processing system 1100 includes random access memory (RAM) 1120; read-only memory (ROM) 1115, wherein the ROM 1115 could also be erasable programmable read-only memory (EPROM) or electrically erasable programmable read-only memory (EEPROM); and input/output (I/O) adapter 1125, for connecting peripheral devices such as disk units 1130, optical drive 1136, or tape drive 1137 to system bus 1110; a user interface adapter 1140 for connecting keyboard 1145, mouse 1150, speaker 1155, microphone 1160, or other user interface devices to system bus 1110; communications adapter 1165 for connecting processing system 1100 to an information network such as the Internet or any of various local area networks, wide area networks, telephone networks, or the like; and display adapter 1170 for connecting system bus 1110 to a display device such as monitor 1175. Mouse 1150 has a series of buttons 1180, 1185 and can be used to control a cursor shown on monitor 1175.

It will be understood that processing system 1100 can include other suitable data processing systems without departing from the scope of the present disclosure. For example, processing system 1100 can include bulk storage and cache memories, which provide temporary storage of at least some program code in order to reduce the number of times code must be retrieved from bulk storage during execution.

Various disclosed embodiments can be implemented in hardware, software, or a combination containing both hardware and software elements. In one or more embodiments, the invention is implemented in software, which includes but is not limited to firmware, resident software, microcode, etc. Some embodiments can be realized as a computer program product, and can be implemented as a computer-usable or computer-readable medium embodying program code for use by, or in connection with, a computer, a processor, or other suitable instruction execution system.

For the purposes of this description, a computer-usable or computer readable medium can be any tangible medium that can contain, store, communicate, or transport the program for use by or in connection with an instruction execution system, apparatus, or device. By way of example, and not limitation, computer readable media can include any of various types of computer storage media, including volatile and non-volatile, removable and non-removable media implemented in any suitable method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

It will be understood that the end-lock joinery system can include other components, elements, or interfaces without departing from the scope of the present disclosure. Furthermore, although particular embodiments have been discussed above, the invention is not limited to the disclosed embodiments, but includes subject matter encompassed by the scope of the appended claims.

What is claimed is:

1. A first elongated member comprising:
a first end portion comprising a protrusion, a shoulder, and a recess;
the protrusion formed from no more than a first half of a thickness of the first elongated member, and having a width that smoothly tapers from a wider portion proximate to the shoulder to a narrower portion distal from the shoulder and proximate to an end of the first elongated member; and
the recess formed from no more than a second half of the thickness of the first elongated member and having a width that smoothly tapers away from a wider mouth proximate to the shoulder to a narrower portion distal from the shoulder and closer to a second end portion of the first elongated member.

2. The elongated member of claim 1, further comprising:
at least one aperture extending through at least part of the first end portion and is configured to receive a fastener.

3. The elongated member of claim 2, further comprising:
a first aperture extending through an inner surface of the protrusion, but not extending through an outer surface of the protrusion;
a second aperture extending through an inner surface of the recess, but not extending through an outer surface of the protrusion; and
wherein the inner surface of the protrusion and the recess are configured to be unseen after being mated with a corresponding recess and protrusion.

4. The elongated member of claim 2, the fastener further comprising a rivet.

5. The elongated member of claim 1, further comprising:
at least one curved surface of the first elongated member extending in an arc, the angle subtended by the arc of the curved surface equaling up to forty-five degrees.

6. The elongated member of claim 1, wherein:
opposite sides of the protrusion each:
extend in a concave arc having a first radius from the shoulder to a first point;
taper from the first point to a second point proximate to the narrower portion of the protrusion;
the narrower portion of the protrusion forming a convex arc having a second radius and extending between the second points of the opposite sides of the protrusion;
opposite sides of the wider mouth of the recess each:
extend in a concave arc having a first radius from the shoulder to a third point;
taper from the third point to a fourth point proximate to the narrower portion of the recess; and
the narrower portion of the recess forming a convex arc having a second radius and extending between the fourth points of the opposite sides.

7. The elongated member of claim 1, wherein:
the first elongated member is constructed of a material having a grain pattern extending substantially parallel to a length of the first elongated member; and
the protrusion and the recess are devoid of cuts parallel to the length of the first elongated member.

8. The elongated member of claim 1, wherein:
the first end portion is configured to mate with a corresponding protrusion and recess formed in a second elongated member.

9. A lap joint comprising:
a first protrusion and a first recess formed in a first member, the first protrusion and the first recess lapped and mated with a matching second recess and second protrusion formed in a second member;
the first protrusion comprising a width tapering along a length of the first protrusion, outward from a shoulder of the first member and terminating in an arcuate end, and configured to mate with the second recess;
the first recess comprising a width tapering along a length of the first recess, inward from a shoulder of the first member to an arcuate end, and configured to mate with the second protrusion;
the second protrusion comprising a width tapering along a length of the second protrusion, outward from a shoulder of the second member and terminating in an arcuate end, the second protrusion configured to mate with the first recess; and
the second recess comprising a width tapering along a length of the second recess, inward from a shoulder of the second member to an arcuate end, and configured to mate with the first protrusion.

10. The lap joint of claim 9, further comprising:
a first aperture extending through at least part of the first protrusion and configured to receive a fastener;
a second aperture extending through at least part of the second recess and configured to receive the fastener; and
a fastener inserted into the first aperture and the second aperture.

11. The lap joint of claim 9, the lap joint attaching elongated members that combine to form a pre-designed structure.

12. The lap joint of claim 11, the pre-designed structure used to form additional structures.

13. The lap joint of claim 9, wherein:
opposite sides of the first protrusion, the second protrusion, the first recess and the second recess extend in concave arcs from the shoulder to respective first points, and taper from the respective first points to respective arcuate ends.

14. The lap joint of claim 9, wherein:
at least the first member is constructed of a material having a grain pattern extending substantially parallel to a length of the first member; and
the protrusion and the recess are devoid of cuts parallel to the length of the first elongated member.

15. A method of cutting an elongated member for use in a lap joint, the method comprising:
loading a computer readable file defining a lap joint design to be cut into a first end portion of the elongated member;
the design including definitions usable to cut a protrusion, a shoulder, and a recess;
the design defining the protrusion to be cut from no more than a first half of a thickness of the elongated member, and having a width that smoothly tapers from a wider portion proximate to the shoulder to a narrower portion distal from the shoulder and proximate to an end of the elongated member;
the design defining the recess to be cut from no more than a second half of the thickness of the elongated member, and having a width that smoothly tapers away from the shoulder to a narrower portion distal from the shoulder and closer to a second end portion of the first elongated member; and
cutting the elongated member in accordance with the computer readable file.

16. The method of claim 15, further comprising:
cutting at least one aperture extending through at least part of the first end portion and is configured to receive a fastener.

17. The method of claim 15, further comprising:
cutting at least one curved surface out of the first elongated member extending in an arc, the angle subtended by the arc of the curved surface equaling up to forty-five degrees.

18. The method of claim 15, further comprising:
cutting the protrusion out of the first end portion, the cutting of the protrusion comprising:
cutting, on opposite sides of the shoulder of the first end portion, a surface curving in a concave arc having a first radius from the shoulder to a first point,
cutting, on opposite sides of the first end portion, a first surface tapering from the first point to a second point proximate to the narrow portion of the protrusion,
cutting a narrower portion of the protrusion comprising a surface curving in a convex arc having a second radius and extending between the second points of the opposite sides of the first end portion; and
cutting the recess out of the first end portion, the cutting of the recess comprising:
cutting, on opposite sides of the wider mouth of the first end portion, a surface curving in a concave arc having the first radius from the shoulder to a third point,
cutting, on opposite sides of the first end portion, a second surface tapering from the third point to a fourth point proximate to the narrow portion of the recess, and
cutting a narrower portion of the recess comprising a surface curving in a convex arc having the second radius and extending between the fourth points of the opposite sides of the first end portion.

19. The method of claim 15, wherein the first member is constructed of a material having a grain pattern extending substantially parallel to a length of the first member; and
the protrusion and the recess are devoid of cuts parallel to the length of the first elongated member.

20. The method of claim 15, the cutting performed by at least one computer numerical control (CNC) machine tool.
